(19) United States
(12) Patent Application Publication
(10) Pub. No.: US 2005/0162438 A1
(43) Pub. Date: Jul. 28, 2005

(54) System including address generator and address generator

(76) Inventors: Hiroaki Nakata, Kawasaki (JP); Yukio Fujii, Yokohama (JP); Kazuhiko Tanaka, Fujisawa (JP); Koji Hosogi, Hiratsuka (JP); Masakazu Ehama, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/984,974

(22) Filed: Nov. 10, 2004

(30) Foreign Application Priority Data
Jan. 26, 2004 (JP) 2004-016737

(51) Int. Cl. G09G 5/37; G06F 12/06

(52) U.S. Cl. 345/572

(57) ABSTRACT

There are provided a system including an address generator and its address generator, capable of generating an address needed for resolution conversion or the like of display data, by using an adder and counters without using a multiplier, which is disadvantageous as regards the mounting area and operation speed when mounting the address generator on an integrated circuit. A first portion for selecting a value from a plurality of values prepared to calculate the next address and adding the selected value, and a second portion for generating a signal to control selection of the value to be added are prepared. A plurality of counters are prepared in the second portion, and the value to be added is selected based on values in these counters. This address generator is incorporated in a DMA controller, memory access controller, display controller or the like, to implement resolution conversion or the like.

### INCORPORATION BY REFERENCE

The present application claims priority from Japanese application JP 2004-016737 filed on Jan. 26, 2004, the content of which is hereby incorporated by reference into this application.

### BACKGROUND OF THE INVENION

The present invention relates to a system including an address generator that generates an address required when accessing a memory, such as a direct memory access (DMA) controller, a display controller or a memory controller, and relates to its address generator.

In JP-A-5-158464, a display resolution conversion circuit is shown and an address generator is described. In the address generator described in JP-A-5-158464, an X-address and a Y address are generated individually in association with X and Y coordinates of the display. The X address and the Y address are supplied to a memory for display individually. The X address and the Y address are changed in synchronism with a clock for reading out display data from the display memory. Resolution conversion in the Y direction is implemented by providing the Y address with a decimal fraction. Resolution conversion in the X direction is implemented by sampling data taken out once from the display memory with a clock different from the readout clock.

A display controller described in JP-A-6-301373 includes a head address generator circuit and an address counter as a portion for generating an address of a display memory, includes a thinning counter as a portion for thinning reference signals used to generate addresses when expanding an image in the vertical direction, and changes reset timing for the thinning counter by one horizontal scanning line depending upon whether the line is an odd-numbered line or an even-numbered line. In an image expanded in the vertical direction, therefore, notches on a slant fine line are blurred and a smooth expanded image in the vertical direction is obtained.

In a liquid crystal display controller described in JP-A-2000-56735, it is made possible to display a longitudinal double size character by converting the display position address so as to yield the same address every twice and displaying the same data so as to extend over two lines.

In JP-A-2000-10705, an output image deformation scheme for expanding and outputting the periphery around a mouse cursor position on the display screen is described. In JP-A-2000-10705, it is made possible to change deformation of a picture image by preparing a plurality of address translation lists and altering the address translation list on the basis of a movement of a mouse cursor.

In a method described in JP-A-5-158464, however, management is conducted by using two addresses, i.e., an X address and a Y address. If a one-dimensional memory address is needed for ordinary memory access, means for generating the one-dimensional memory address from the X address and the Y address becomes necessary. If at this time the range of the X address is indicated by an integer-th power of 2, the X address and the Y address should be assigned to a bit field of the memory address having a one-dimensional configuration. If the number of pixels in the X direction is not an integer-th power of 2, it is necessary to set the range of the X address equal to the number of pixels in the X direction in order to suppress the waste in the display memory. In such a case, a multiplier becomes necessary to generate a one-dimensional memory address from the X address and the Y address and a circuit scale required for address generation becomes large. The multiplier becomes slow in operation than the adder, and it is disadvantageous in designing a circuit needing fast operation.

In the method disclosed in JP-A-5-158464, display data read out from the memory is subjected to sampling using a clock different from a clock used for address generation and memory access and subjected to resolution conversion. It is inconvenient in altering the system configuration.

In JP-A-6-301373, the technique of blurring notches on a slant fine line in an expanded image in the vertical direction and obtaining a smooth expanded image in the vertical direction is disclosed. However, a technique of expanding and contracting an image in both the vertical direction and the horizontal direction is not disclosed.

In JP-A-2000-56735, conversion conducted so as to set the display position address equal to the same address every twice is described. However, details of the address generation method are not described. In addition, display of characters other than longitudinal double size characters is not taken into consideration at all.

In JP-A-2000-10705, it is described to prepare a plurality of address translation lists and expand and display the periphery of the cursor position by using the address translation lists. However, a concrete method for creating the address translation list is not described.

### SUMMARY OF THE INVENTION

The present invention provides a system including an address generator and its address generator, capable of generating a necessary address by using an adder and counters without using a multiplier, which is disadvantageous as regards the mounting area and operation speed when mounting the address generator on an integrated circuit.

A portion for selecting a certain value from a plurality of values prepared to calculate the next address and adding the selected value, and a portion for generating a signal to control selection of the value to be added are prepared. A plurality of counters are prepared in the portion for controlling the selection of the value to be added, and the value to be added is selected on the basis of values in these counters.

It becomes possible to obtain a system including an address generator and its address generator, capable of generating a necessary address by using an adder and counters without using a multiplier, which is disadvantageous as regards the mounting area and operation speed when mounting the address generator on an integrated circuit.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration example of a first embodiment of an address generator included in a system that includes an address generator according to the present invention;

FIG. 2 is a diagram showing an internal configuration example of a condition decider included in an address generator of a first embodiment;

FIG. 3 is a diagram showing a relation between a disposition of line data on a memory and a display position on a display screen as an example of display resolution conversion conducted by using an address generator of an embodiment according to the present invention;

FIG. 4 is a diagram showing operation of an address generator of an embodiment according to the present invention, in association with the example shown in FIG. 3;

FIG. 5 is a diagram showing a configuration example of a system including an address generator according to the present invention;

FIG. 6 is a diagram showing an example of an internal configuration of a DMA controller shown in FIG. 5;

FIG. 7 is a diagram showing a configuration example of a second embodiment of an address generator included in a system that includes an address generator according to the present invention; and

FIG. 8 is a diagram showing a configuration example of a third embodiment of an address generator included in a system that includes an address generator according to the present invention.

### DESCRIPTION OF THE EMBODIMENTS

Hereafter, embodiments of the present invention will be described in detail with reference to the drawings. Throughout all drawings for describing the embodiments, the same components are denoted by like reference numerals and duplicated description thereof will be omitted.

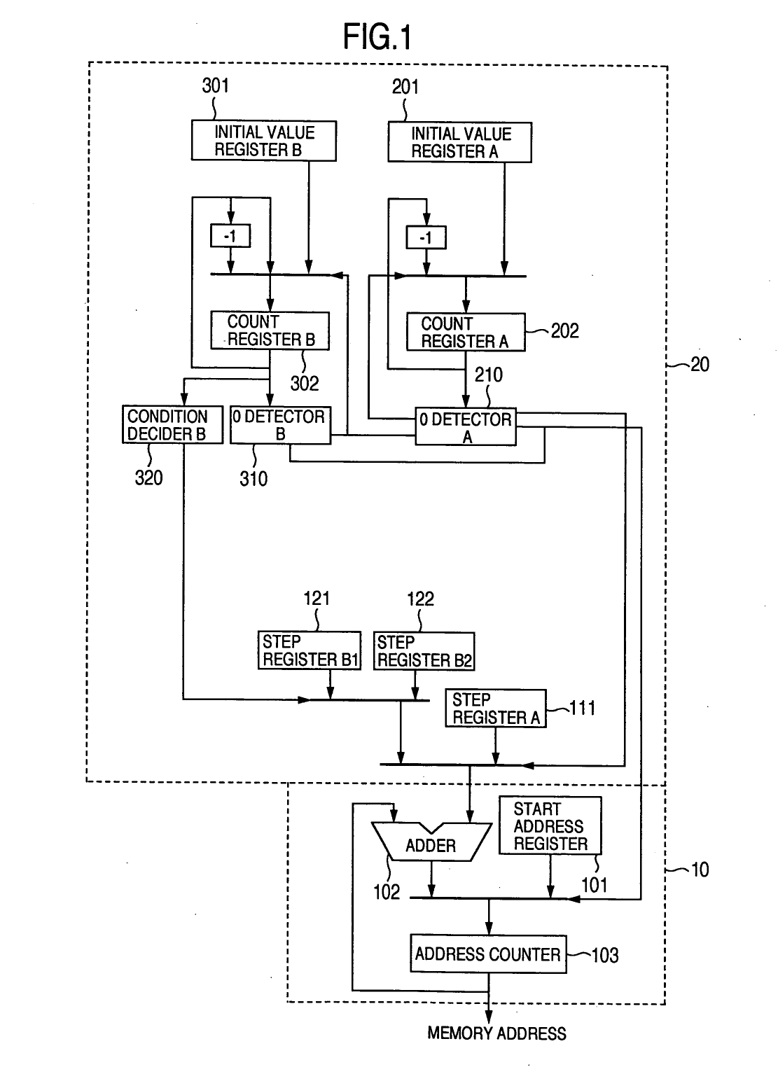

FIG. 1 shows a configuration example of a first embodiment of an address generator included in a system that includes an address generator according to the present invention. An embodiment of a system that includes an address generator according to the present invention will be described later.

As shown in FIG. 1, the address generator of the first embodiment includes an address updater 10 and an address increment selector 20. The address updater 10 updates the address by adding an address increment. The address increment selector 20 includes a plurality of counters in which respective initial values can be set independently, and selects an address increment to be added by the address updater by using values in these counters.

First, the address updater 10 in the address generator of the first embodiment will now be described. As shown in FIG. 1, the address updater 10 includes a start address register 101, an adder 102 and an address counter 103.

The start address register 101 is a register that retains a start address. When conducting display data processing such as the resolution conversion, the start address register 101 sets a head address of a frame buffer area where the display data is stored. As occasion demands, the start address register 101 has a configuration capable of retaining an address below a decimal point. If conversion of the resolution in the main scanning direction (horizontal direction) is conducted in application to resolution conversion, it is necessary sometimes to retain an address below a decimal point in order to conduct fine adjustment on the display start position.

The address counter 103 is a register for retaining the current address. As occasion demands, the address counter 103 has a configuration capable of retaining an address below a decimal point as well. If conversion of the resolution in the main scanning direction (horizontal direction) is conducted in application to resolution conversion, it is necessary sometimes to retain an address below a decimal point.

The adder 102 adds a value in the address counter 103 and a value in some step register 20 in the address increment selector 20 to calculate the next address.

The address increment selector 20 included in the address generator of the first embodiment will now be described. As shown in FIG. 1, the address increment selector 20 includes a step register A 111, a step register B1 121, a step register B2 122, an initial value register A 201, a count register A 202, a 0 detector A 210, an initial value register B 301, a count register B 302, a 0 detector B 310, and a condition decider B 320.

Each of the step register A 111, the step register B1 121 and the step register B2 122 is a register for retaining an address increment. If the address counter 103 retains an address below a decimal point, each of the step register A 111, the step register B1 121 and the step register B2 122 has a configuration capable of retaining an address below a decimal point as well accordingly. Each of the step register A 111, the step register B1 121 and the step register B2 122 retains a sign and is capable of specifying a negative value as well.

The initial value register A 201 retains an initial value for the count register A 202. The 0 detector A 210 detects that the count register A 202 has a value of 0. If the 0 detector A 210 detects that the count register A 202 has a value of 0, the count register A 202 loads the initial value from the initial value register A 201. Otherwise, the count register A 202 decreases the value one by one. This initial value specifies the count period of the count register A 202.

In the present embodiment, the 0 detector detects 0. Instead of the 0 detector, a detector for detecting a specific value may also be used. If the detector detects that the count register A 202 has reached the specific value, an initial value is loaded from the initial value register A 201. Otherwise, the value is decreased one by one. Instead of decreasing one by one, the value may be increased one by one. Instead of decreasing or increasing one by one, the value may be decreased or increased by a count of at least two. These are true of the ensuing description of this embodiment and other embodiments as well.

The initial value register B 301 retains an initial value for the count register B 302. The 0 detector B 310 detects that the count register B 302 has a value of 0. Only when the 0 detector A 210 detects 0, the count register B 302 is updated. If the 0 detector B 310 detects 0 in updating, an initial value is loaded from the initial value register B 301. Otherwise, the value is decreased one by one.

The condition decider B 320 detects whether the value in the count register B 302 satisfies a certain condition.

If both the 0 detector A 210 and the 0 detector B 310 detect 0, the address counter 103 loads the initial value from the start address register 101. If the 0 detector A 210 does not detect 0, the address counter 103 is updated with a value obtained by adding the current address retained in the address counter 103 and the value in the step register A 111. If the 0 detector A 210 detects 0 and the 0 detector B 310 does not detect 0, the address counter 103 is updated with a value obtained by adding the current address retained in the address counter 103 and a value in the step register B1 121 or the step register B2 122.

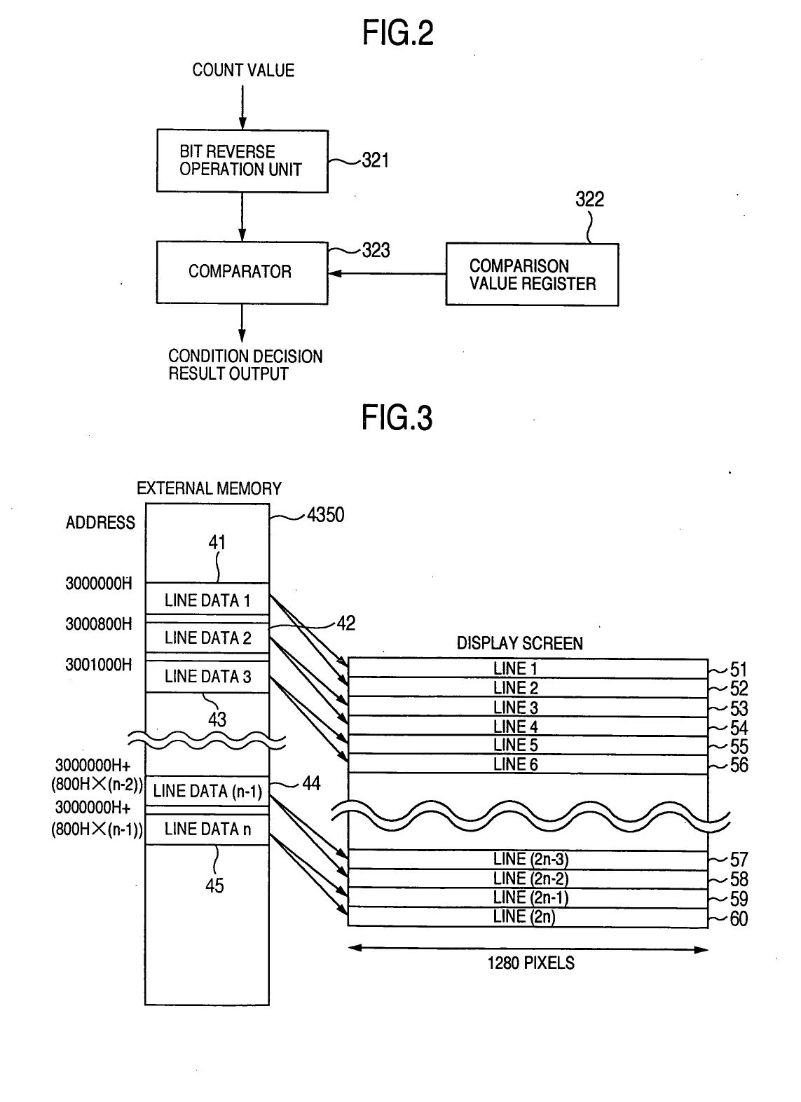

FIG. 2 shows an internal configuration example of the condition decider 320. A count value from the count register B 302 is supplied to the condition decider B 320. At this time, a configuration in which only one bit or several bits on the LSB side of the count value is supplied to the condition decider B 320 is also conceivable. The count value input to the condition decider B 320 is inverted in bit row by a bit reverse operation unit 321, and a result is sent to a comparator 323. The comparator 323 determines whether the sent result is greater than a value set in a comparison value register 322, and outputs this result as a condition decision result. By inverting the count value in bit row and then conducting comparison, a change in condition decision result caused by a change in count value becomes apt to occur. For example, if four low-order bits in the count value is used in the condition decision, the condition decision output is inverted whenever the count value decreases by 1, by setting 8 in the comparison value register 322.

The bit reverse operation unit 321 is a unit for conducting bit reverse, and it inverts the row of input bits and outputs a result. For example, if a four-bit binary number PQRS is input to the bit reverse operation unit 321, its output becomes a binary number SRQP. Here, each of P, Q, R and S is 0 or 1. If the count value successively input to the bit reverse operation unit 321 is, for example, 1111, 1110, 1101, 1100, 1011, . . . , therefore, then the output of the bit reverse operation unit 321 becomes 1111, 0111, 1011, 0011, 1101, . . . . If a decimal number 8, i.e., a binary number 1000 is set in the comparison value register 322, the output of the comparator 323 is inverted each time the count value decreases by 1.

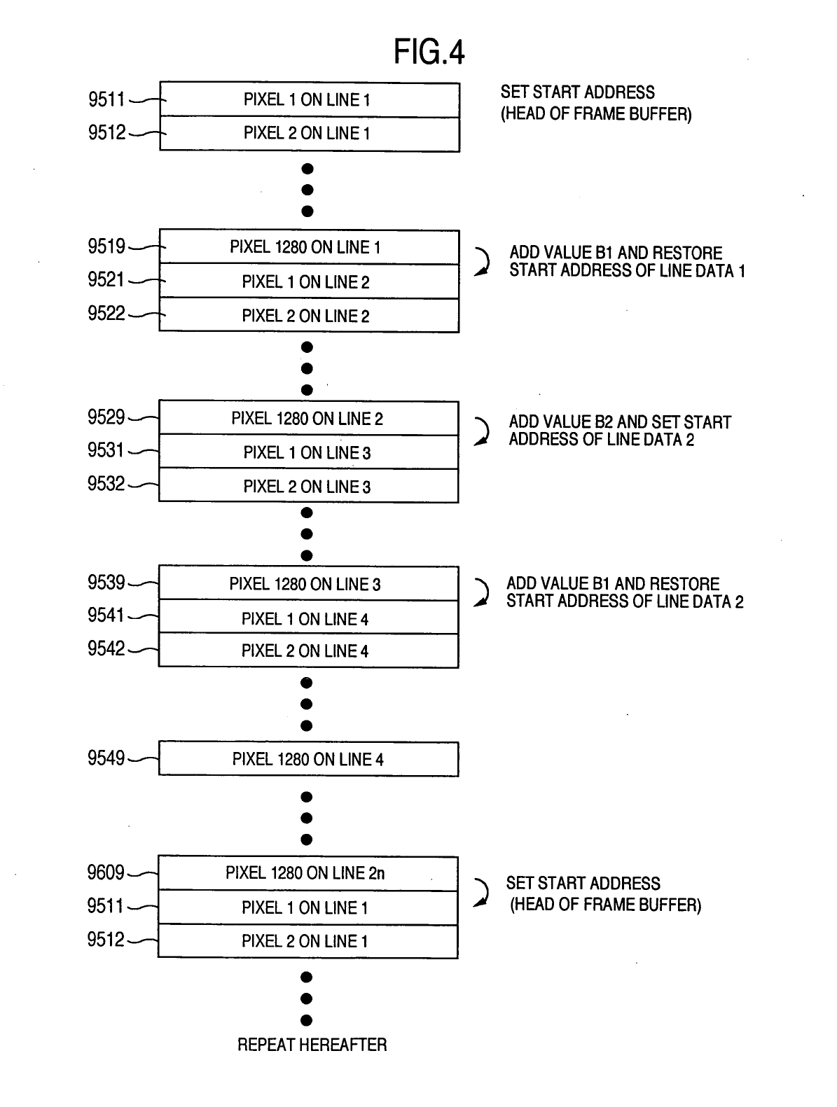

FIG. 3 is a diagram showing a relation between a disposition of line data on a memory and a display position on a display screen as an example of display resolution conversion conducted in a display device, which is a concrete example of a system including an address generator according to the present invention. FIG. 4 is a diagram showing operation of the address generator of the embodiment, in association with the example shown in FIG. 3.

Setting and operation of the address generator will now be described as regards an example in which a view is expanded twice in the longitudinal direction, with reference to FIGS. 3 and 4. In this example, the lateral direction is the main scanning direction, and the longitudinal direction is the subsidiary scanning direction.

In the example shown in FIG. 3, a frame buffer area is prepared from 3000000 H in an external memory 4350, and an area of 800 H bytes is assigned as each line data area. As for data in the frame buffer, one pixel is represented by one byte. This is expanded to twice in the longitudinal direction and displayed on a display screen having 1280 pixels in the lateral direction and 2n pixels in the longitudinal direction.

By taking that the external memory 4350 is formed of an SDRAM or the like into consideration and considering the data transfer efficiency at the time of memory access, the head of each line data area is determined so as to have an address that is a multiple of 800 H. If the size of the data area is important than the data transfer efficiency, however, the case where a gap is not provided between line data areas is also conceivable.

As shown in FIG. 3, contents of the frame buffer are displayed twice in the longitudinal direction by using line data 1 41 to display a line 1 51 and a line 2 52 on the display screen and using line data 2 42 to display a display line 3 53 and a display line 4 54.

When conducting the display as heretofore described, the following setting is conducted in the address generator. In the start address register 101, 3000000H, which is the start address of the frame buffer, is set. Since neither expansion nor compression is conducted in the lateral direction and one byte corresponds to one pixel, 1 is set in the step register A 111. A value obtained by subtracting 1 from the number of bytes included in one line data and inverting the sign, i.e., −1279 is set in the step register B1 121. A value 769 obtained by subtracting 1279, which is obtained by subtracting 1 from the number 1280 of bytes included in one line data, from the line data interval, i.e., 800H, which is 2048 in decimal number representation, is set in the step register B2 122. A value 1279 obtained by subtracting 1 from the number of pixels on one line is set in the initial value register A 201. A value (2n−1) obtained by subtracting 1 from the number of displayed lines is set in the initial value register B 301. The condition decider B 320 is set so as to select the step register B1 121 as an address addition value if an LSB in the count register B 302 is 1 and select the step register B2 122 if the LSB is 0.

An address generation sequence at the time of the above-described setting will now be described with reference to FIG. 4.

First, in the initial value state, the count register A 202 and the count register B have a value of 0. Contents of the start address register 101 are loaded into the address counter 103. Contents of the initial value register A 201 are loaded into the count register A 202. Contents of the initial value register B 301 are loaded into the count register B 302. Therefore, the value in the address counter 103 becomes the head address of the frame buffer, i.e., an address at which first pixel data in the line data 1 41 is present, and indicates data corresponding to the display of the pixel 1 9511 on the line 1. Over which the line 1 51 is displayed, the address counter 103 generates an address required to access the line data 1 41 successively with an increment set in the step register A 111.

If all data in the line data 1 41 are accessed and the address counter 103 indicates data corresponding to the display of a pixel 1280 (9519) on the line 1, then the value in the count register A 202 becomes 0. At this point in time, the value in the count register B 302 is still 2n−1. Therefore, the LSB of the value in the count register B 302 is 1, and the value in the step register B1 121 is selected as the increment of the address counter 103. And the value in the address counter 103 returns to the head address of the line data 1 41. At the same time, the value from the initial value register A 201 is loaded into the count register A 202, and the value in the count register B 302 is decreased by one.

In an interval over which the line 2 52 is displayed, an address is generated successively in the same way as the interval over which the line 1 51 is displayed. If all data in the line data 1 41 have been accessed as the display for the line 2 52 and data corresponding to display of a pixel 1280 (9529) on the line 2 is indicated, the value in the count register A 202 becomes 0. This time, the value in the count register B is still 2n−2 and the LSB of the value in the count register B 302 is 0. Therefore, the value in the step register B2 122 is selected as the increment of the address counter 103. And the address counter 103 is updated to have a head address of the line data 2 42. At the same time, the value from the initial value register A 201 is loaded into the count register A 202, and the value in the count register B 302 is decreased by one.

The above-described operation is repeated. If data corresponding to display of a pixel 1280 (9609) on a line 2n is indicated, the value in the count register A 202 and the value in the count register B 302 become 0. Therefore, the initial state is restored, and the value in the address counter 103 becomes the head address of the frame buffer, i.e., the first pixel data in the line data 1 41 again, and indicates data corresponding to the display of the pixel 1 (9511) on the line 1.

In the above-described operation, values that are different only in the sign are specified respectively in the step register B1 121 and the initial value register A 201. In other words, in application in which certain line data is displayed a plurality of times as in the twice display in the longitudinal direction, a configuration of the address generator in which the step register B1 121 is used also as the initial value register A 201 and only the sign is inverted in the treatment inside is also conceivable.

It is now supposed that compression should be conducted in the longitudinal direction, for example, in a compression ratio of two-thirds. It can be coped with by setting the step register B1 121 so as to make the address counter 103 indicate the head of the next line data after completion of access to data corresponding to one line, setting the step register B2 122 so as to make the address counter 103 indicate the head of the next but one line data after completion of access to data corresponding to one line, and suitably setting the initial value register B 301 and so on.

If compression in the lateral direction, for example, in a ratio of one-second is necessary, it can be coped with by setting 2 in the step register A 111 and setting the initial value A 201 and so on suitably.

For coping with expansion in the lateral direction, a function of retaining a fraction below a decimal point in the step register A 111, the step register B1 121, the step register B2 122 and the address counter 103 becomes necessary. If the start address register 101 can also retain a fraction below a decimal point, it is convenient. In this case, an integer part in the address counter 103 is used as the memory address. If expansion to twice should be conducted as an example of expansion in the lateral direction, it can be coped with by setting 0.5 in the step register A 111 and setting the initial value register A 201 and so on suitably.

When taking out a memory address from the address counter 103, even the case where the data amount per pixel is not one byte can be coped with by providing a function of masking low-order bits regardless of whether there is a fraction part in the address counter. For example, the case where the data amount per pixel is 4 bytes can be coped with by masking two low-order bits of the integer part as well.

If neither expansion nor compression is conducted in the lateral direction and the data amount per pixel is also fixed, the value in the step register A 111 can be determined uniquely. Depending upon the configuration, therefore, it is conceivable that the step register A 111 is not prepared, but a fixed value is used instead.

By the way, it is possible to display an image inverted in up-down direction and/or left-right direction by setting the step register A 111, the step register B1 121, the step register B2 122, the initial value register A 201, and the initial value register B 301 so as to generate the address contrary to the scanning direction.

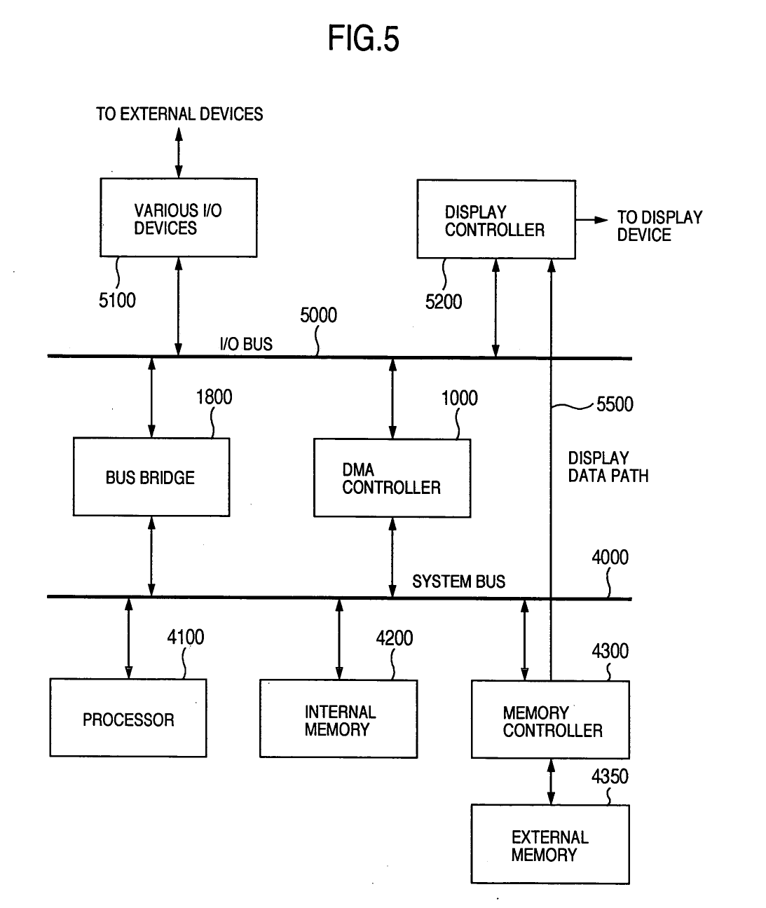

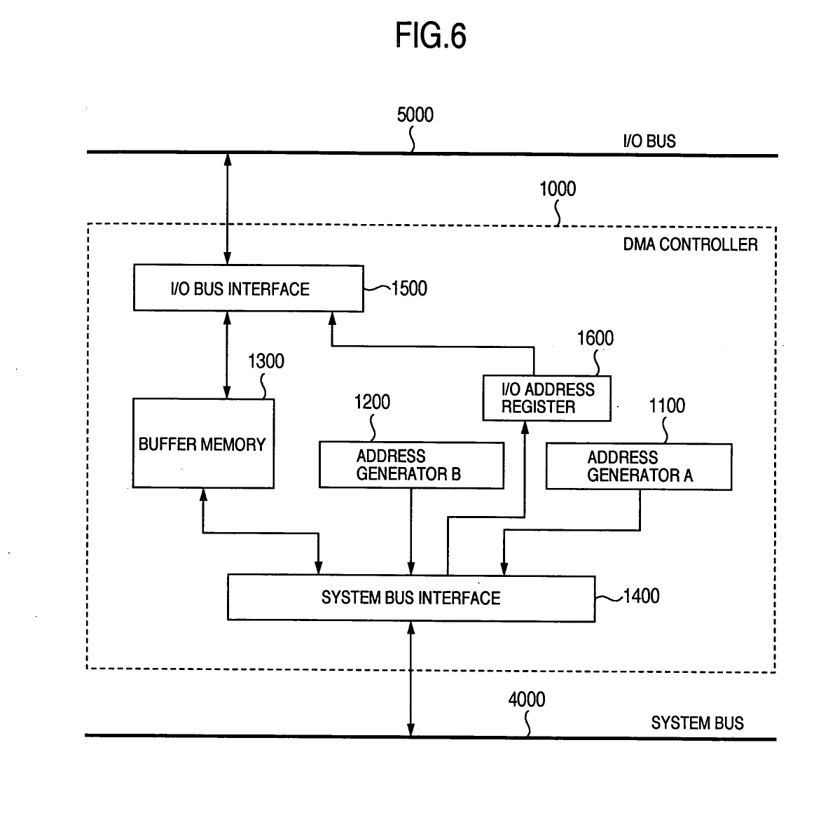

FIG. 5 shows an embodiment of a system including the address generator according to the present invention. FIG. 6 shows an example of an internal configuration of a DMA controller (direct memory access controller) 1000 shown in FIG. 5.

An embodiment of a system including the address generator according to the present invention will now be described with reference to FIGS. 5 and 6.

A processor 4100 is a micro processor or a digital signal processor, which conducts computation processing or system control. An internal memory 4200 is coupled directly to a system bus 4000. Although the internal memory 4200 is comparatively as small as approximately several Kbytes to 1 Mbytes in capacity, it can be accessed fast from the processor 4100 or the DMA controller 1000.

A memory controller 4300 controls an external memory 4350 in accordance with an access request for the external memory 4350 issued by the processor 4100 or the DMA controller 1000. It is also possible to take out display data from a frame buffer, which is present in the external memory 4350, and send the display data to a display controller 5200 via a display data path 5500. The external memory 4350 is comparatively as large as approximately-several Mbytes to 1 Gbytes, and the external memory 4350 includes, for example, an SDRAM or a DDR-SDRAM.

Various I/O devices 5100 are input/output interfaces such as a serial interface, a parallel interface and an audio interface.

A display controller 5200 receives data included in the frame buffer via an I/O bus 5000 or the display data path 5500, adds a synchronous signal and so on required for screen display to the data, and outputs resultant data to a display device. The display controller 5200 can receive display data via the DMA controller 1000 and receive display data directly from the memory controller 4300 via the display data path 5500.

A bus bridge 1800 is a bridge provided between the system bus 4000 and the I/O bus 5000, and it is used by the processor 4100 to access the various I/O devices 5100 or the display controller 5200.

The DMA controller 1000 conducts transfer of data that is present in the internal memory 4200 or the external memory 4350, and conducts data transfer between the internal memory 4200 or the external memory 4350 and the various I/O devices 5100 or the display controller 5200.

FIG. 6 shows an example of an internal configuration of the DMA controller-shown in FIG. 5.

A system bus interface 1400 for connection to the system bus 4000 and an I/O bus interface 1500 for connection to the I/O bus 5000 are included within the DMA controller 1000. Both the system bus interface 1400 and the I/O bus interface 1500 are connected to a buffer memory 1300. Data input from the system bus interface 1400 or the I/O bus interface 1500 is stored in the buffer memory 1300 once and output to respective buses via the system bus interface 1400 or the I/O bus interface 1500 by taking a suitable data amount as the unit.

An I/O address register 1600 retains an address that identifies a device located on the I/O bus 5000 side or an I/O register that is present in the device, at the time of direct memory access transfer.

An address generator A 1100 and an address generator B 1200 generate addresses required to access the internal memory 4200 or the external memory 4350. The address generator according to the present invention is used as the address generator A 1100 and the address generator B 1200. Depending upon the system configuration, however, it is also conceivable to an address generator of a different form as one of the address generator A 1100 and the address generator B 1200.

In the case where memory-memory transfer is conducted by the DMA controller 1000, both the address generator A 1100 and the address generator B 1200 are used, and the address generators generate addresses of the transfer source and transfer destination, respectively.

In the case where memory-I/O transfer is conducted by the DMA controller 1000, a memory address is generated by either the address generator A 1100 or the address generator B 1200, and data transfer is conducted between the memory and an I/O device indicated by the I/O address register 1600. It is possible to specify a display data input of the display controller 5200 as the data transfer destination by setting in the I/O address register 1600.

In the case where a frame buffer area is prepared in the external memory 4350 in the system shown in FIG. 5 and display data that is present in the area is subjected to resolution conversion and output to the display controller 5200, the display controller 5200 is set so as to receive display data from the I/O bus 5000 whereas the DMA controller 1000 is set so as to conduct the memory-I/O transfer and setting in the address generators in the DMA controller 1000 is conducted according to the method described above.

In the system shown in FIG. 5, the address generators according to the present invention are included in the DMA controller 1000. If two frame buffer areas are prepared on a memory and the memory-memory transfer is conducted by the DMA controller 1000, therefore, an image subjected to resolution conversion can be generated within the memory even when display is not conducted on the display device.

In addition, in the system shown in FIG. 5, the internal memory 4200 is prepared. By dividing the frame buffer area prepared in the external memory 4350 into a plurality of areas and previously transferring data from an area required for processing to the internal memory 4200 by using the DMA controller 1000 in accordance with a sequence of conducting image processing in the processor 4100, therefore, it is possible to suppress the speed falling caused by memory access time taken when the processor 4100 conducts processing. In this case, it is also possible to conduct resolution conversion at the time of data transfer before the processor 4100 conducts processing. If the processor 4100 writes a result of processing into the internal memory 4200 and the result is suitably output to the external memory 4350 by the DMA controller 1000, it is also possible to conduct the resolution conversion on the result of the processing conducted by the processor 4100 and write a result into the external memory 4350.

In the system shown in FIG. 5, the display data can be supplied to the display controller 5200 by using the display data path 5500 without intervention of the DMA controller 1000. By using the display data path 5500, the load on the system bus 4000 and the I/O bus 5000 can be suppressed when outputting an image to the display device. Since the DMA controller 1000 is not used, however, the resolution conversion cannot be conducted. Depending upon the system configuration, therefore, it is likely to make resolution conversion possible even at the time of transfer of the display data via the display data path 5500 by preparing the address generator according to the present invention in the memory controller 4300 or the display controller 5200. For example, if the address generator is prepared in the memory controller 4300, then the memory controller 4300 conducts address generation at the time of frame buffer access for display device output, accesses the external memory 4350 on the basis of the generated address, and sends the display data read out to the display controller 5200 via the display data path 5500. As a result, it becomes possible to output an image subjected to the resolution conversion, to the display device even via the display data path 5500.

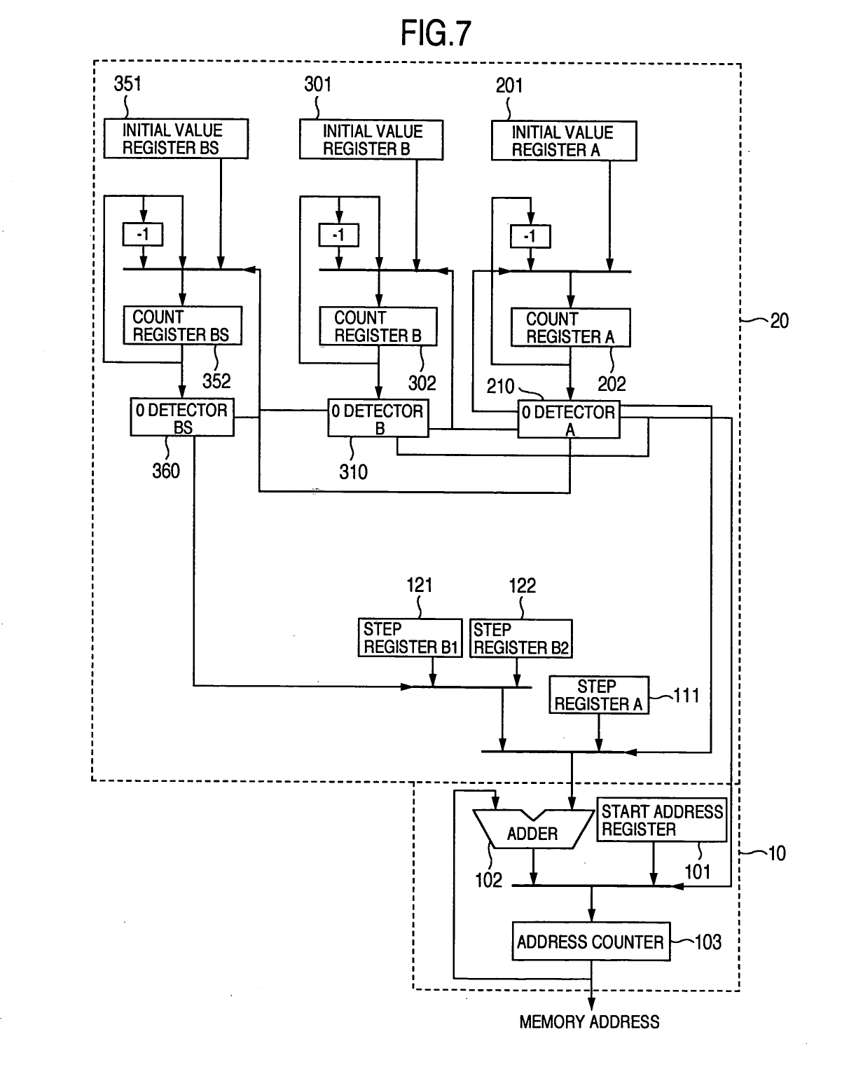

FIG. 7 shows a configuration example of a second embodiment of an address generator in a system including an address generator according to the present invention.

The address generator according to the second embodiment shown in FIG. 7 has a configuration in which a counter is added instead of the condition decider B 320 in the address generator according to the first embodiment shown in FIG. 1. Selection on the step register B1 121 and the step register B2 122 is conducted by a count register BS 352, which is the added counter. In other words, a decision is made by using a 0 detector BS 360 whether a value in the count register BS 352 is 0, and either the step register B1 121 or the step register B2 122 is selected on the basis of the decision.

An initial value register BS 351 retains an initial value of the count register BS 352. Only when the 0 detector A 210 has detected 0, the count register BS 352 is updated. If the 0 detector B 310 or the 0 detector BS 360 detects 0 in updating, an initial value is loaded from the initial value register BS 351. Otherwise, the value is decreased one by one.

The address generation required for expansion to twice in the longitudinal direction described with reference to FIGS. 3 and 4 can be implemented in the address generator shown in FIG. 7, by conducting basically the same setting as that in the address generator shown in FIG. 1 and specifying 1 in the initial value register BS 351.

In the configuration of the address generator shown in FIG. 7 as well, basically the same setting as that in the address generator shown in FIG. 1 is conducted. In application in which certain line data is displayed a plurality of times as in the twice display in the longitudinal direction, a configuration of the address generator in which the step register B1 121 is used also as the initial value register A 201 and only the sign is inverted in the treatment inside is also conceivable.

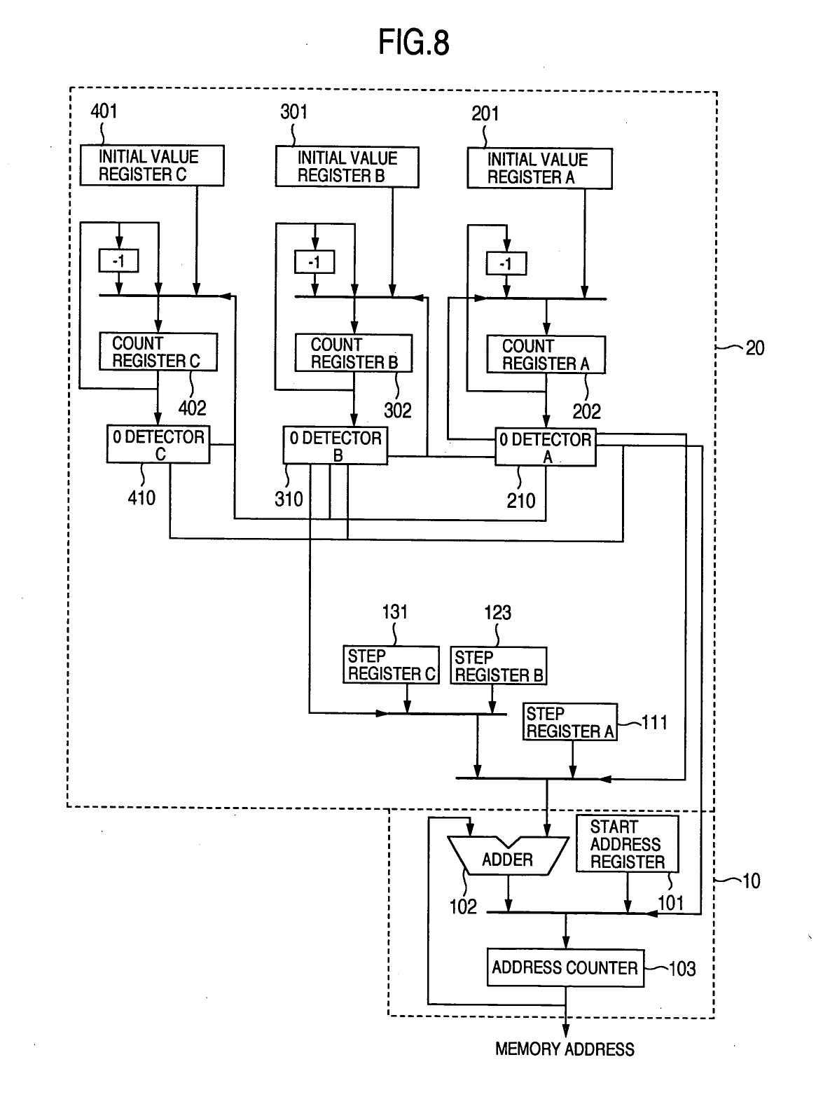

FIG. 8 shows a configuration example of a third embodiment of an address generator in a system including an address generator according to the present invention.

The address generator according to the third embodiment shown in FIG. 8 has a configuration in which a counter is added by using a method different from that in the second embodiment of the address generator shown in FIG. 7, instead of the condition decider B 320 in the address generator according to the first embodiment shown in FIG. 1.

In the address generator shown in FIG. 7, the count register BS 352, which is the added counter, operates basically in synchronism with the count register B 302. In the address generator shown in FIG. 8, however, the added count register C 402 changes only when both the 0 detector A 210 and the 0 detector B 310 have detected 0. In other words, the address generator shown in FIG. 8 has a configuration of a three-dimensional address generator.

When the count register C 402 changes, an initial value is loaded from the initial value register C 401, if the 0 detector C 410 has detected 0. Otherwise, the value is decreased one by one.

The step register B1 121 and the step register B2 122 used to specify the increment value in FIG. 1 are replaced by the step register B 123 and the step register C 131 in FIG. 8.

If all of the 0 detector A 210, the 0 detector B 310 and the 0 detector C 410 have detected 0, the address counter 103 loads an initial value from the step register A 111. If the 0 detector A 210 has not detected 0, the address counter 103 is updated with a value obtained by adding a current address retained in the address counter 103 and a value stored in the step register A 111. If the 0 detector A 210 has detected 0 and the 0 detector B 310 has not detected 0, the address counter 103 is updated with a value obtained by adding the current address and a value stored in the step register B 123. If the 0 detector A 210 and the 0 detector B 310 have detected 0 and the 0 detector C 410 has not detected 0, the address counter 103 is updated with a value obtained by adding the current address and a value stored in the step register C 131.

In order to conduct address generation required for expansion to twice in the longitudinal direction described with reference to FIGS. 3 and 4, by using the address generator shown in FIG. 8, the following setting is conducted. 3000000H, which is the start address of the frame buffer, is set in the start address register 101. Since neither expansion nor compression is conducted in the lateral direction and one byte corresponds to one pixel, 1 is set in the step register A 111. A value obtained by subtracting 1 from the number of bytes contained in one line data and inverting the sign, i.e., −1279 is set in the step register B 123. A value 769 obtained by subtracting 1279, which is obtained by subtracting 1 from the number 1280 of bytes included in one line data, from the line data interval, i.e., 800H, which is 2048 in decimal number representation, is set in the step register C 131. A value 1279 obtained by subtracting 1 from the number of pixels on one line is set in the initial value register A 201. Since it is necessary to update the address counter with an address of the next line data once every two display lines, 1 obtained by subtracting 1 from 2 is set in the initial value register B 301. Since the count register C 402 is updated once every two display lines, (n−1) obtained by subtracting 1 from half the number of displayed lines is set in the initial value register C 401.

As for the configuration of the address generator shown in FIG. 8 as well, in application in which certain line data is displayed a plurality of times as in the twice display in the longitudinal direction, a configuration of the address generator in which the step register B 123 is used also as the initial value register A 201 and only the sign is inverted in the treatment inside is also conceivable.

The address generators shown in FIGS. 7 and 8 are obtained by altering only the counter configuration in the address generator shown in FIG. 1, and they can be applied to the system shown in FIG. 5 in the same way as the address generator shown in FIG. 1. Since all of the address generators shown in FIGS. 1, 7 and 8 have configurations that are possible in synchronous design at the time of logic design, they can be easily introduced into a place where they become necessary from the viewpoint of the system configuration, such as the DMA controller or the memory controller.

For example, when constituting an address generator, a portion for selecting a certain value from a plurality of values prepared to calculate the next address and adding the selected value, and a portion for generating a signal to control selection of the value to be added are prepared. A plurality of counters are prepared in the portion for controlling the selection of the value to be added, and the value to be added is selected on the basis of values of these counters. When conducting resolution conversion on display data, the address generator is incorporated in the DMA controller, the memory access controller, the display controller or the like and display data is acquired from the memory on the basis of the result of address generation. Acquired data are output successively in synchronism with pixel display timing in the display device.

According to the embodiments of the present invention as heretofore described, it becomes possible to generate an address required for resolution conversion of the display data by using an adder and counters without using a multiplier, which is disadvantageous as regards the mounting area required for mounting on an integrated circuit and the operation speed. Since resolution conversion can be conducted by conducting memory access according to the output result of the address generator, the resolution conversion function can be easily introduced in a place where it becomes necessary from the viewpoint of the system configuration, such as the DMA controller or the memory controller. Furthermore, even if the frame buffer area is arranged in a memory densely without depending upon the image resolution, it is possible to conduct the resolution conversion at the time of display, by suitably conducting the setting concerning the address generator, and a system in which a requirement for the memory capacity is strict can also be coped with. If the address generator according to the present invention is applied to the DMA controller, it becomes possible not only to expand or compress the contents of the frame buffer and display them but also to conduct resolution conversion at the time of transfer between frame buffers. In addition, it also becomes possible to make the processor operate efficiently by previously transferring data needed by the processor for computation from the frame buffer to the internal memory at the time of image processing. Furthermore, it also becomes possible to conduct the resolution conversion before or after the processor conducts image processing. If the address generator according to the present invention is applied to the memory controller or the display controller, the resolution conversion at the time of display becomes possible even in a system in which the memory controller is directly coupled to the display controller by the display data path.

It is advantageous in respect of the processing speed to constitute devices in the embodiments by using hardware. However, a part or all of the devices in the embodiments may be constituted by using software and a computer.

Heretofore, the invention made by the present inventors has been described concretely on the basis of the embodiments. However, the present invention is not limited to the embodiments. It is a matter of course that various changes can be made without departing from the spirit of the invention.

1. A system including an address generator for generating an address needed at time of memory access, said address generator comprising:
an address updater for updating an address by adding an increment of the address; and
an address increment selector having a plurality of counters in which respective initial values can be set independently and a plurality of registers, each for specifying increment of said address, said address increment selector selecting the increment of the address on the basis of a value in at least one counter included in the counters.

2. A system including an address generator, according to claim 1, wherein at least one increment of the address and at least one of counter initial values are shared and retained by the same setting register.

3. A system including an address generator, according to claim 1, wherein
the counters include a first counter and a second counter, and
a value in said second counter is updated when said first counter has a specific value, and an address increment is selected by a value in said second counter when said first counter has a specific value.

4. A system including an address generator, according to claim 1, wherein
the counters comprise a first counter, a second counter and a third counter, and
values in said second counter and said third counter are updated when said first counter has a specific value, and
an address increment is selected by a value in said third counter when said first counter has a specific value.

5. A system including an address generator, according to claim 1, wherein
the counters comprise a first counter, a second counter and a third counter, and
a value in said second counter is updated when said first counter has a specific value, a value in said third counter is updated when said first counter and said second counter has specific values respectively, and an address increment is selected by a value in said second counter when said first counter has a specific value.

6. A system including an address generator for generating an address needed at time of memory access, said address generator comprising:
a start address register for specifying a start address;
a first counter;
a first initial value register for specifying a count period of said first counter;
a second counter for counting every count period of said first counter;
a second initial value register for specifying an initial value of said second counter;
a first step register for specifying an increment of the address when said first counter has a value different from a specific value; and
a second step register and a third step register selected on the basis of a value in said second counter to specify the increment of the address when said first counter has a specific value and said second counter has a value different from a specific value.

7. A system including an address generator, according to claim 6, comprising an address generator that has said first initial value register for specifying a count period of said first counter and said second step register or said third step register as one register.

8. A system including an address generator, according to claim 6, comprising an address generator that uses a fixed value as a substitute for said first step register.

9. A system including an address generator for generating an address needed at time of memory access, said address generator comprising:
a start address register for specifying a start address;
a first counter;
a first initial value register for specifying a count period of said first counter;
a second counter for counting every count period of said first counter;
a second initial value register for specifying an initial value of said second counter;
a third counter for counting every count period of said first counter;
a third initial value register for specifying an initial value of said third counter;
a first step register for specifying an increment of the address to be used when said first counter has a value different from a specific value;
a second step register for specifying the increment of the address to be used when said first counter has a specific value and said third counter has a specific value; and
a third step register for specifying the increment of the address to be used when said first counter has a specific value and said third counter has a value different from a specific value.

10. A system including an address generator, according to claim 9, comprising an address generator that has said first initial value register for specifying a count period of said first counter and said second step register or said third step register as one register.

11. A system including an address generator, according to claim 9, comprising an address generator that uses a fixed value as a substitute for said first step register.

12. A system including an address generator for generating an address needed at time of memory access, said address generator comprising:
a start address register for specifying a start address;
a first counter;
a first initial value register for specifying a count period of said first counter;
a second counter for counting every count period of said first counter;
a second initial value register for specifying an initial value of said second counter;
a third counter for counting every count period of said second counter;
a third initial value register for specifying an initial value of said third counter;
a first step register for specifying an increment of the address to be used when said first counter has a value different from a specific value;
a second step register for specifying the increment of the address to be used when said first counter has a specific value and said second counter has a specific value; and
a third step register for specifying the increment of the address to be used when said first counter has a specific value and said second counter has a value different from a specific value.

13. A system including an address generator, according to claim 12, comprising an address generator that has said first initial value register for specifying a count period of said first counter and said second step register or said third step register as one register.

14. A system including an address generator, according to claim 12, comprising an address generator that uses a fixed value as a substitute for said first step register.

15. A system including an address generator, according to claim 1, wherein said system is a DMA transfer controller for conducting data transfer between a memory and a memory or between a memory and an I/O.

16. A system including an address generator, according to claim 1, wherein said system is a display controller for generating a signal to be output to a display device.

17. A system including an address generator, according to claim 1, comprising:
a memory controller for controlling memory access;
a display controller for generating a signal to be output to a display device; and
a data path for directly transferring display data from said memory controller to said display controller,
wherein said memory controller comprises said address generator.

18. A system including an address generator, according to claim 1, comprising:
a memory controller for controlling memory access;
a DMA controller capable of conducting data transfer between a memory and an I/O; and
a display controller for generating a signal to be output to a display device,
wherein said display controller can receive display data from said DMA controller, and said DMA controller comprises said address generator.

19. A system including an address generator, according to claim 1, comprising:
a memory controller for controlling memory access;
a DMA controller capable of conducting data transfer between a memory and a memory; and
a processor for conducting computation processing,
wherein said processor has an accessible internal memory, said DMA controller can access said internal memory as well, and said DMA controller comprises said address generator.

20. An address generator for generating an address needed at time of memory access, said address generator comprising:
an address updater for updating an address by adding an increment of the address; and
an address increment selector having a plurality of counters in which respective initial values can be set independently, said address increment selector selecting the increment of the address on the basis of values in the counters.
